(19) United States
(12) Patent Application Publication
(10) Pub. No.: US 2003/0154306 A1
(43) Pub. Date: Aug. 14, 2003

(54) System and method to proxy inbound connections to privately addressed hosts

(76) Inventor: Stephen Hastings Perry, Plymouth, MA (US)

Correspondence Address: Stephen Hastings Perry, 10 Langford Rd., Plymouth, MA, 02360, US

(21) Appl. No.: 10/347,374

(22) Filed: Jan. 21, 2003

Related U.S. Application Data
(60) Provisional application No. 60/355,600, filed on Feb. 11, 2002.

(51) Int. Cl. G06F 15/16; G06F 15/173

(52) U.S. Cl. 709/245; 709/239

(57) ABSTRACT

A system and method for network address translation that enables an inbound connection from the public network to a privately addressed host residing on a private network. The stated invention functions as a reverse proxy mechanism assigning a dynamic port number to uniquely identify each inbound connection from the public network to a host on the private network. The defined proxy device uses regular and reverse mapping and employs use of the passive command to notify the client on the public network of the said unique port number assigned for the inbound connection. When the session is completed, the port is returned to the pool to be reassigned as needed.

### CROSS-REFERENCE TO RELATED APPLICATIONS

This application claims priority from U.S. provisional patent application Serial No. 60/355,600, filed Feb. 2, 2002, which is herein incorporated by reference for all purposes.

### OTHER REFERENCES

Rekhter, Y., “Address Allocation for Private Internets”, February 1996, Network Working Group, RFC 1918.

Srisuresh, P., “IP Network Address Translator (NAT) Terminology and Considerations”, August 1999, Network Working Group, RFC 2663.

Srisuresh, P., “DNS extensions to Network Address Translators (DNS_ALG)”, September 1999, Network Working Group, RFC 2694.

Srisuresh, P., “Traditional IP Network Address Translator (Traditional NAT)”, January 2001, Network Working Group, RFC 3022.

Holdrege, M., “Protocol Complications with the IP Network Address Translator”, January 2001, Network Working Group, RFC 3027.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of the Invention

The present invention relates, in general, to private network access and, more particularly, access to hosts, services and devices on a private network that are configured with a private address.

2. Discussion of Related Art

Without limiting the scope of the present invention, this background of the present invention is described in connection with distributed name servers, in particular the Domain Name System is cited in the patent documentation.

There are several software-based techniques, such as NAT (Network Address Translation), RAT (Reverse Address Translation), RAPT (Reverse Address and Port Translation), Round Robin DNS, IP Masquerading and other methods of address translation using a reverse proxy device that provide methods for resolving multiple IP addresses to a single IP address or DNS name. These techniques focus on statically mapping a public IP address to one or a group of private IP addresses. These techniques have been successful in providing access to specific applications that can be offered at a fixed port, typically for load balancing, but has not proven to be a flexible or scalable process for inbound address translation.

Static mapping is typically implemented when an organization needs to publish IP addresses for public servers, such as FTP and Web, but does not wish to expose the real IP addresses of those servers. Static mapping, with just one IP visible to the public network for enabling inbound connections to multiple hosts on the private network, requires listening on different ports, one for each service mapped to the internal IPs. Efforts to expand these techniques to create a more dynamic process, that is not port or application specific, have been largely unsuccessful. Incoming connections in a dynamic environment are impossible with these techniques, since even when a host has an entry in a masquerading or state table of such a proxy device this entry is only valid for the connection being active to a reachable service or port.

As a result networks are typically split between the public side of the network and private side of the network. Split DNS refers to using separate internal and external DNS views of your domain's network using internal and external name servers. This split network, between the private and the public, is the result of legacy technologies including RFC 1918 Private IP addressing. The limitation of split DNS is that the internal DNS forwards address resolutions to the external DNS, but the external DNS does not forward address resolutions from the public network to the internal DNS. The reasoning is that an internal DNS could resolve a host name to the public network, but this host name is typically resolved to a private IP address that would be non-routable across the public network.

Private IP addresses are the recommended IP address ranges that networks can use for hosts that do not require direct access to the Internet. The private IP address range standard was defined by the IETF in RFC 1918, although IP address ranges used on a private network are not exclusive to this standard. These addresses are for use on private networks (filtered by Internet Routers) and therefore do not have to be globally unique. These addresses can be used without fear of duplicating a unique IP address owned by another enterprise. Private IP addresses are yet another device conceived to deal with exhaustion of the IP address space, which was never considered in the original design of the Internet.

The IETF RFC 1918 standard has defined three networks for use privately. No hosts on the Internet are allowed to use these addresses. They are defined as class A, B, and C subnets.

10.0.0.0-10.255.255.255 (10/8 prefix)

172.16.0.0-172.31.255.255 (172.16/12 prefix)

192.168.0.0-192.168.255.255 (192.168/16 prefix)

These defined addresses are non-routable across the Internet. TCP/IP packets containing these addresses, as either a source or destination address, will be dropped by routers residing in nodes on the public Internet.

Private IP addresses can be configured for outbound connectivity to the Internet by using a methodology called Network Address Translation (NAT). Using a proxy server that takes a client's request from the internal private network rewrites the IP address, and in some instances the port number, in the packet header and sends it to the Internet and then when it returns—relays the message back to the user on the internal network. In this situation, all of the devices on a private network have private IP addresses, and the server need only have one global IP address, or a pool of globally unique IP addresses. Because these private IP addresses cannot be routed across the Internet, NAT is required to give these private IP addresses a public IP address so that they can connect across the Internet. As described above, there are several versions of this methodology including Port Address Translation (PAT) that are used primarily for outbound connectivity, and statically configured inbound connectivity. However, there is no current method of dynamic inbound connectivity to hosts addressed with a private IP address.

### SUMMARY OF INVENTION

Other features and advantages of the present invention shall be apparent to those of ordinary skill in the art upon reference to the following detailed description taken in conjunction with the accompanying drawings.

Briefly stated, the present invention enables IP hosts on a private network to be accessed from a public network (or the Internet) without requiring an administrator to assign a globally unique IP address to each system. The invention also allows for these hosts on a private network to be accessed without allocating a specific port or service for inbound connectivity. The stated invention involves a system and method for port address translation for inbound connections to a private address. The proxy interface is configured with only (1) public IP address, and acts as a translator to hosts on the public network or Internet who can access private hosts through the proxy interface. Inbound connections to a host name are resolved and then mapped to this single public IP address and a unique TCP or UDP port number is selected by the proxy device to map the inbound connection to the host private address.

The stated invention creates a very special method of dynamic NAT called reverse port address translation where many IP numbers are hidden behind a single one and a unique port number is used for inbound session identification. The methodology of the stated invention is called Reverse Port Address Translation (RPAT) and a device using this methodology is called an ‘RPAT device’. The methodology of an RPAT device for inbound connection establishment to a host assigned a private address located on a private network is done by assigning a unique port address to the inbound connection. The unique port address assigned by the RPAT device to the inbound connection is established dynamically by use of the passive command between the RPAT device and a client initiating the connection. The passive command is a standard networking technology that represents a connection redirect command that is utilized by the present invention in a unique manner to notify the client of the dynamic port number that has been assigned to the connection for the purpose of NAT. The stated invention, defines a process of establishing dynamic ports and a method of mapping them to privately addressed hosts for the purpose of enabling a unique method of NAT for inbound connections to non-routable private IP addresses.

The present invention involves two conceptual redirection activities. The first is a reverse proxy for address resolution, and the second is a reverse proxy for data transfer to hosts located on a private network. Specific to this documentation the stated invention defines address resolution using a Domain Name System (DNS) reverse proxy, but may function as a reverse proxy for ARP, an XML DTD, or any method of host, object or data identification based on numerical or character definition. A host name is passed from the public network to the RPAT device, acting as a reverse proxy for a DNS, the RPAT device then forwards the host name to the internal DNS for resolution. The RPAT device receives a private IP address resolution to the host name from the internal DNS and proxies its global IP address as the address for the private host in the packet header destination address field. Since the global IP address of the RPAT device is a shared address, used as a proxy address by all the hosts on the private network, a unique port number is assigned to each connection as the method of identifying each individual inbound connection as being assigned to a particular host on the private network. To notify the client, which initiated the connection request, of the unique port that the RPAT device is listening on for the inbound connection to the host on the private network the RPAT device replies to the passive command, issued by the client, as the process of notifying the client of the unique port to connect to. The RPAT device then maps the unique port number to the private address returned from the internal DNS in an address table (or state table) which the RPAT device maintains as long as the session is active and removes the mapping from the address table based upon a preset timer once session activity has ceased.

### BRIEF DESCRIPTION OF THE DRAWINGS

FIG.1 illustrates a general distributed computing environment in which the present invention is implemented;

FIG.2 illustrates a conceptual diagram showing entity relationships for both client-to-server and server-to server architectures maintained by the system in accordance with the present invention;

FIG.3 shows a diagram with internal and external port assignments with addressing configuration on two hardware servers defined in the present invention;

FIG.4 shows two embodiments of the present invention using a domain name system deployed in an implementation of the present invention;

FIG.5 illustrates a detailed breakdown of the message processing platform functions for packet redirection;

FIG.6 diagrams the methodology of reverse port address translation;

FIG.7 shows diagram of an example address table showing mappings of dynamically assigned port numbers to privately addressed hosts;

FIG.8 shows a functional diagram of the passive command functionality in accordance with the present invention for unique port assignment of inbound connections.

### DETAILED DESCRIPTION OF THE PREFERRED EMBODIMENT

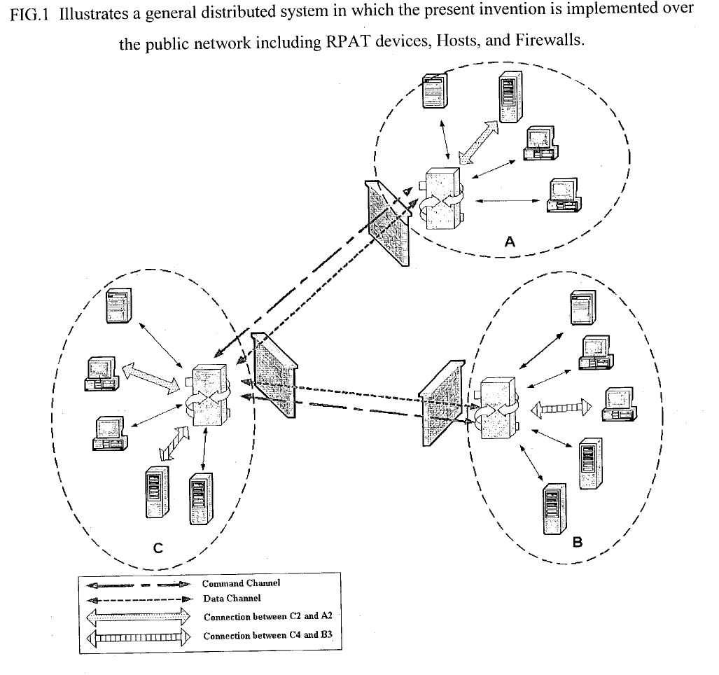

In FIG. 1 the diagram is a preferred embodiment of the network including the invention detailed with regard to hosts, nodes, Local Area Networks (LANs), firewalls and the Internet. Those skilled in the art would recognize after perusal of this diagram that embodiments of the invention can be implemented using any application built on the Layer 3 and 4 protocol stack of the OSI model for data exchange, and general purpose processors or special purpose host clients adapted to particular process steps and data structures described herein, and that implementation of the process steps and data structures described herein would not require undue experimentation or further invention.

The current state of the art in technology provides no efficient mechanism for hosts outside the LAN C network to connect to hosts inside the LAN C network, assigned RFC 1918 addresses, without hosts “C1”, “C2”, “C3”, “C4” and “C5” first establishing an outbound connection and socket at the firewall or a proxy server. The RPAT device and addressing system as described in this invention provides a method for host A2 in FIG. 1, which resides outside the LAN C network, also referred to as a cluster, to connect to host C2 without C2 first establishing an outbound connection or socket at an application proxy or firewall.

Most hosts, as defined in FIG. 1, are connected to LANs that reside behind a firewall. Organizations may have many LANs each residing behind a router and connected to a WAN that resides behind a firewall. However the private network may be configured, in the present invention the hosts on the network collectively form a cluster. Hosts on a cluster are interconnected by an RPAT device, which typically resides at one access point into the global-interconnect system, or Internet. Each of the clusters in FIG. 1 represents a network segment and may consist of many sub-sets, although it is not specifically a stub network. The RPAT device develops sophisticated address tables to map inbound connections and to create peer-to-peer network segments across physically separate networks connected to the Internet, bridging the private to public disconnect as it relates to host addressing and inbound connectivity. The legacy addressing system of most LANs typically comprises private IP addresses, which are not routable addresses on the Internet, and thus does not allow a peer node to be accessed from outside the private network.

It is important to note in the art a node is a host with a direct connection to the Internet. Not all hosts are nodes. A node that has access to the public network acts as a proxy for the hosts that do not have a connection to the public network or Internet and rewrite the packet header before parsing packets to these hosts. The client on the public network talks to this proxy server instead of directly to the host on the private network. To the client on the public network this proxy server is transparent, talking to the proxy server is just like talking to the real host on the private network. In FIG. 1 each node, referred to as an RPAT device, is a proxy for a cluster of hosts. In the diagram nodes representing RPAT LAN A, RPAT LAN B, and RPAT LAN C create a federation of RPAT devices that connect hosts on each of these network clusters together.

The concept of clusters is a key component of address discovery in the defined network. Each cluster is a network with regular topology, known to the hosts in the cluster. The RPAT device acts as the node connecting the cluster to the public network and is a hub for the cluster of hosts. The RPAT device represents the cluster of hosts, which is typically defined by a physical network topology, such as a subnet, Local Area Network (LAN) or Wide Area Network (WAN) running behind a firewall. The cluster may also represent a group of wireless or remote dial users that are not defined by a logical physical connection. These hosts register with a name server or look-up service for discovery across the private network, this name server is proxied by the stated invention to advertise these hosts across this federation of RPAT devices on the public network. The network topology is not restricted to a public network and may exist across a private WAN or other network configuration. In the topology identified in FIG. 1 the RPAT device represents a cluster of hosts to the public network. In this typical architecture the network is split between the LAN/WAN and the Internet, between the private network and the public network. Where these two meet is not easily or efficiently bridged. The RPAT device is the software platform to proxy the discovery, and resolution for privately addressed hosts, and proxies the access and security to bridge the public and private network together in a true peer-to-peer architecture for data transfer. In FIG. 1, we show the defined network containing both public hosts on the Internet and private hosts on LAN C connecting through the stated invention.

Clustered networks may generally be composed of any of the following components:

1. Local-Area Networks (LANs)

LANs may have a variety of designs, typically based upon bus, ring, or star topologies. In general, a LAN will cover a small geographical area (e.g., a single building or plant site) and provide high bandwidth with low delays.

2. Wide-Area Networks (WANs)

Geographically-dispersed hosts and LANs are interconnected by wide-area networks, also called long-haul networks. These networks may have a complex internal structure of lines and packet-routers (typified by Intranets and Extranets), or they may be as simple as point-to-point lines.

3. Remote Access Networks (RAS)

The cluster may also represent a group of wireless or remote dial users that are not defined by a logical physical connection. A group of wireless or remote dial users are defined by their ability to log in and register a DHCP, NAT or other dynamic address with a look-up or name server or directly with the RPAT device so that connection requests may be forwarded to the global IP address of the RPAT device.

In the defined network model, clusters are connected together by RPAT devices. An RPAT device functions as either a proxy or reverse proxy server depending on the direction of the connection. For an outbound connection the device is a proxy and is considered ‘Active’, while for an inbound connection the device is a reverse proxy and considered ‘Passive’. An RPAT device is a host gateway for a cluster and can be either an Active RPAT device to proxy outbound connections or Passive RPAT device to reverse proxy inbound connection requests. The RPAT device resides inside the firewall on an advertised port. This advertised port is the command channel identified in FIG. 1. An Active RPAT forwards a URI to a Passive RPAT on this command channel. The Passive RPAT either resolves the URI to a physical address itself or redirects the request to the internal DNS or other name server. Once an address has been resolved the Passive RPAT then creates a dynamic port and maps this port in an address table to the resolved address. As a reverse proxy the Passive RPAT redirects data packets traversing this dynamic port according to the mapping of a unique connection socket to the private address of the host. This dynamic socket is identified as the data channel in FIG. 1. In current practice, an RPAT device normally interacts with special-purpose client software, which is required for network access after address resolution. This special purpose client software passes the passive command to the Passive RPAT device over the command channel. An RPAT device may be a stand-alone computer system, dedicated to its addressing, routing, and proxy functions. Alternatively, it is possible to embed RPAT device functionality within a network file server operating system, which supports connections to two or more networks.

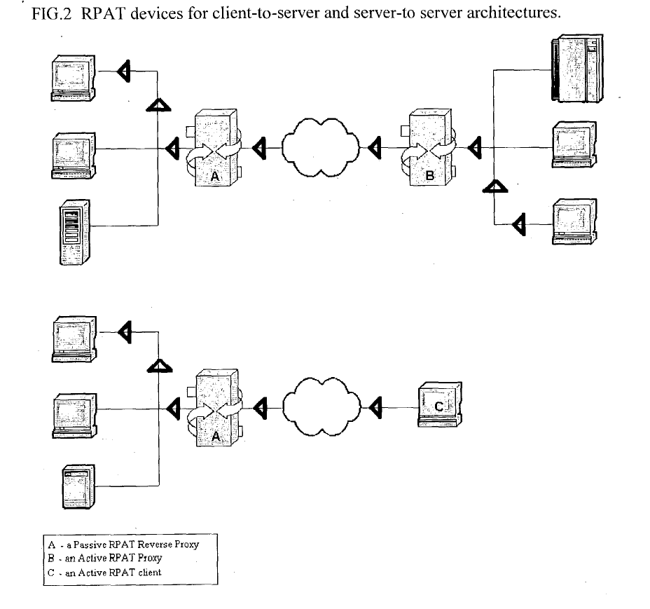

Clusters have been previously defined as a collection of hosts. Hosts are either active or passive in the defined network as diagramed in FIG.2. An active host initiates a connection. The connection of an active host is outbound. A passive host receives the connection. The connection to a passive host is inbound and has not been initiated or requested by the passive host. In a host-to-server environment only the Passive RPAT device reverse proxy is used, in a server-to-server methodology both an Active RPAT device to proxy and a Passive RPAT device to reverse proxy are used. In FIG. 2, the active host requests a connection to a passive host.

The user initiating the request is known as the active host and the user to whom they are connecting to is known as the passive host. The active host, in FIG. 2 Server-to-Server Configuration, connects to the Active RPAT, which represents the cluster to the public network, to locate the passive host. The Active RPAT forwards the request to the Passive RPAT device and issues a passive (PASV) command to establish the data connection (asking the Passive RPAT device which port to connect to). The Passive RPAT device resolves the address, maps the listing in a address table and issues a PASV reply (notifying the Active RPAT which unique port it has assigned to this one connection, it will then tear the port down when the connection is closed). Once the session is established the Passive RPAT device, as a reverse proxy, readdresses the packet and uses a broadcast, multicast or unicast method of forwarding the session packets to the passive host. The passive host listening to the network receives the packet redirected by the RPAT device to the physical address that identifies the passive host on the private network. The Passive RPAT device is a broker or middleman that stands between a host on the Internet and a host inside the private network.

In particular the invention relates to a general-purpose programmable message-processing platform identified as an RPAT device. An RPAT device receives messages on one or more input interfaces and outputs those messages on one of a plurality of output interfaces, so as to move those messages from a source device on the public network to a destination device on the private network defined as a cluster and vice versa. Each message includes header information, which indicates the destination address (and other information relating to the network segment said device or plurality of said devices), and the RPAT device includes routing information, which associates an output interface with information about the destination address and its network segment (possibly with other information). The RPAT device also performs other operations on messages, such as rewriting the message header before distribution to a host inside the cluster or to re-encapsulate the packets before distribution to a host outside the cluster.

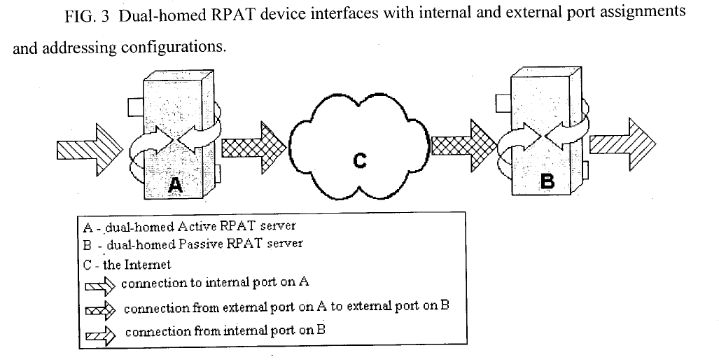

The active host uses client software to establish a connection with the Active RPAT that represents the cluster. In FIG.3 the client sends a connection request over the LAN Ethernet addressed to the 10.10.1.1 LAN port on the dual-homed RPAT device gateway (acting as a connection proxy) referred to in FIG. 3 as the Active RPAT and defined as the forward slash arrow. The client requests a connection to a passive host. The passive host is connected to a different RPAT device (acting as a reverse proxy) referred to in FIG.3 as the Passive RPAT device. The Active RPAT (acting as the proxy) readdresses the source address of the packet with its global IP address (128.51.74.5) and then forwards a TCP connection request to the Passive RPAT device (acting as the reverse proxy) at IP address 128.51.73.8, this connection flow is defined as the checkered arrows in FIG. 3. Once a TCP session has been established through the stated methodology of the invention the Passive RPAT device readdresses the packet and forwards it to the passive host with the internal serial port as the source address (10.10.1.7) and defined as the back slash arrow in the diagram.

An RPAT device is dual-homed and may be connected to one or more networks, appearing to each of these networks as a connected node. Thus, it has one or more physical interfaces and an IP address assigned to each of these interfaces representing the connected networks. Forwarding a host address request generally requires the RPAT device to choose the address of the next-hop Passive RPAT device or (for the final hop) the destination host. This choice, called “routing”, depends upon a routing database maintained by the RPAT device and a routing algorithm (or static configuration) to determine the next-hop. Hosts on a private network proxy all peer connections, both outbound (Active RPAT) and inbound (Passive RPAT), through the RPAT device. Once a connection is established the RPAT device is configured to continue proxying all data packets in the established TCP or UDP session.

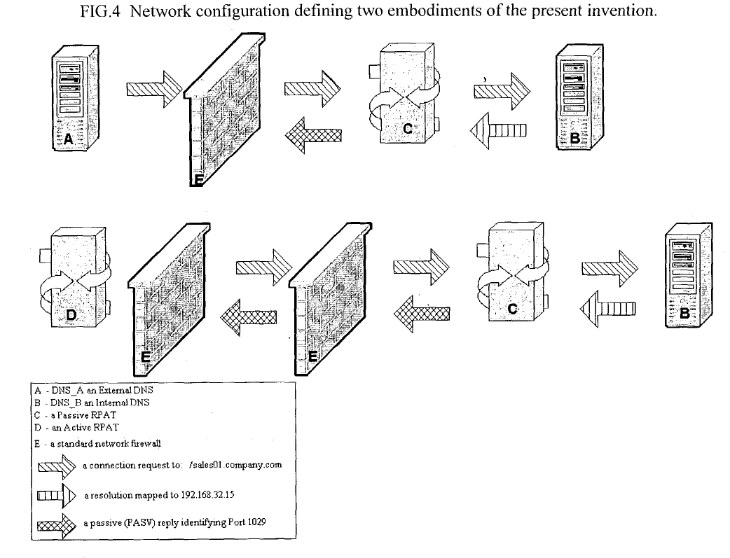

The embodiment of the RPAT system defined in this patent is built on the Internet Protocol (IP), the Transmission Control Protocol (TCP) and depends upon them. The RPAT device uses TCP/IP as the basic data transport mechanism. This also means networks that use TCP-based protocols (i.e. HTTP) for the data exchange. But RPAT device is not restricted to TCP, it can also be used for ‘unreliable’ transport protocols like UDP for name resolution. The stated invention is diagramed in FIG. 4 and described using the Domain Name System (DNS) as the method of network addressing, however, the invention is not limited to this protocol and any method of host identification based on numerical or character definition may be used for addressing. On a TCP/IP network, computers use IP addresses to find each other. IP addresses are the unique identifiers for every computer and device on the Internet. But on the Internet as on a Local Area Network, users normally rely on computer names because they are easier to remember. A computer's Internet address consists of two basic components: a host name and a domain name. A host name is the name of a computer, usually the name you give a computer when you set up a network and is mapped to an IP address using a name server. A domain name is typically an organization name used to identify a network on the Internet, this address is typically mapped to an IP address using a DNS server. The domain name is used along with the host name to create a Fully Qualified Domain Name (FQDN) for a computer.

Split DNS refers to using separate internal and external DNS views of a domain network using internal and external name servers. The typical configuration is for the internal name servers to forward queries they can't resolve to the external name server. Under Berkeley Internet Name Domain (BIND) 4, the “forwarders” directive is used for this. In BIND 8 systems, the “forwarders” substatement is used to configure forwarding. External DNS records are configured to contain only a small zone file for the domain, listing things such as Web and FTP server addresses and any translated server addresses that need to be published to the world. The internal servers hold only the DNS records for internal networks. When internal users look-up host names the query is answered by internal DNS servers, if the request is not resolved it is forwarded to an external DNS server for resolution. However, the external DNS does not forward resolution requests from the public network to the internal DNS. When Internet users look up host names in a domain they are answered by external DNS servers that only know about the publicly accessible resources.

This split network, between the private and the public, is the result of legacy technologies including Private IP addressing, NAT, and firewalls. The physical network address of a host registered to the internal DNS is usually a private address, this private address is typically an RFC 1918 address that is a shared address not associated with or assigned to any one particular domain on the Internet, or it may even be an address range not owned by the organization. A private address is characterized as unpublished and non-routable across the public Internet. The internal DNS maps private network addresses, typically based on RFC 1918, to FQDNs, but does not reach across the public network or provide address discovery outside the private network. An External DNS server is used for this, but it provides no address mapping to resources inside the private network, or typically beyond the DMZ.

The diagram in FIG. 4 describes the implementation of the stated invention to overcome this using DNS, however, it is to be understood that any look-up or name server such as WINS or Jini could be used. The domain name service is implemented as a distributed database managed by domain name servers (DNSs) such as DNS_A and DNS_B shown in FIG. 4 First Embodiment. In a Split DNS configuration DNS_A represents an external DNS server, which is primary or authoritative DNS for the domain, and DNS_B represents the internal DNS server, that resolves internal address queries. The external DNS relies on <domain name:IP> address mapping data stored in master files and the internal DNS relies on <host name:IP> address mapping. In FIG.4 Second Embodiment, an RPAT client, such as an Active RPAT device, forwards a host name resolution to the Passive RPAT device, which is acting as a proxy for the internal DNS. The external DNS in this diagram, represented as DNS_A, is bypassed. The Passive RPAT device then forwards the host name resolution request to DNS_B for resolution. DNS_B resolves the host name (sales01.company.com) to the IP address (192.168.32.15) and returns this private IP address to the Passive RPAT device. The Passive RPAT device then forwards the PASV reply to the Active RPAT and bind the connection at this socket address. The Passive RPAT device does not return this private address resolution (192.168.32.15) to DNS_A or directly to the client.

FIG. 4 is shown with both an external DNS and an Active RPAT forwarding discovery requests to the Passive RPAT. In accordance with the present invention, a Split DNS configuration is deployed in FIG. 4 with an internal DNS used for address resolution by system components of the present invention. When an active host requests access to a privately addressed network resource (e.g., a passive host), the application used by the active host (e.g., a browser, peer-to-peer client, etc.) can either contact the RPAT device located on the hosts cluster to resolve the requested domain name into its related IP address, or it may also be configured to contact its own internal DNS system in a conventional manner. Both embodiments are diagramed in FIG. 4.

The use of programs such as resolver and forward that are standard to BIND provide resolution to address queries in a distributed system that enable the external DNS to forward this request to the Passive RPAT device. Resolver includes an address of a DNS that serves as a primary name server. When presented with a reference to a domain name (e.g., http://www.jumpernetworks.com), resolver sends a request to the primary DNS (e.g., DNS_A in FIG. 4). The primary DNS returns either the IP address mapped to that domain name, or implements the forward directive to another DNS, which has the mapping information, or a partial IP address together with a reference to another DNS that has more IP address information.

In the First Embodiment of FIG. 4, the internal DNS forwards the resolution to the external DNS, which performs a conventional DNS resolution directing the browser (or client application) to a root server, which forwards the request to the second-level DNS, which, in-turn, forwards the request to the system owned DNS server (i.e., DNS_A in FIG. 4). The external DNS (i.e., DNS_A) then directs the request using the forward directive to the Passive RPAT device, which is a reverse proxy for the internal DNS (i.e., DNS_B), the Passive RPAT device looks to the internal DNS for resolution and then proxies the destination address of the requested passive host on resolution.

In the Second Embodiment of FIG. 4, when an active host requests access to a privately addressed network resource (e.g., a passive host), the application used by the active host (e.g., a browser, peer-to-peer client, etc.) contacts its own internal DNS to resolve the requested domain name into its related IP address in a conventional manner. However, the internal DNS does not forward the request to the public DNS, but forwards the request to the RPAT device previously defined as an Active RPAT. The application used by the active host may also forward the address resolution directly to the Active RPAT. The Active RPAT performs a private DNS resolution, using a next-hop methodology the Active RPAT forwards the address resolution for the passive host to other Passive RPAT device servers. The Passive RPAT device servers, which represent a reverse proxy for the internal DNS (i.e., DNS_B), look to the internal DNS for resolution. If no resolution is provided to the request, the Passive RPAT device then forwards the request to each of the RPAT device servers listed in its forward table. This embodiment represents a private system of linking internal DNS servers together through a federation of RPAT devices.

The methodology of the RPAT device described herein is a reverse proxy for the internal DNS server. This allows the external DNS to forward resolution requests from the public network to the Passive RPAT device. The user inside the LAN can advertise their presence without making their private address known to the world. The host inside the LAN instead advertises a URI, a file name, or a service to the public network. The stated invention makes no determination of the type of advertisement, which may be a host name, URI, XML DTD, character string, numbering system such as MAC or any other method. In accordance the stated invention makes no determination of the type of name server. The Passive RPAT device maps the private address to the address of the proxy and a uniquely assigned port so that clients can locate private resources from the public network.

The stated invention uses the method of passive port assignment to enable a unique system and method of Port Address Translation for inbound connections (technically it enables a system of reverse Port Address Translation). RPAT, as the stated invention defines, is the methodology to reverse proxy requests to hosts on a private network assigned a private address. The use of the passive command for passive port assignment is used by the RPAT device to create a unique socket address to proxy access to a host, or plurality of hosts, residing on a private network.

The passive command establishes a dynamic port for each inbound connection allowing the public IP address of the dual-homed RPAT device to be used as the proxy interface for all hosts on the private network cluster. The use of passive port assignment allows a single IP address on the external serial port (this may also be an Ethernet port) of the RPAT device to act as an agent between the Internet (or “public network”) and a local (or “private”) network. Allowing only a single, unique IP address to represent an entire group of computers that are using a private addressing scheme. Passive port assignment creates a dynamic port for each inbound connection which identifies each connection with a unique 5-tuple SOCKS address. The stated invention then provides a methodology for mapping this unique SOCKS address to the private address of the host on the private network.

The Passive RPAT device is a reverse proxy for the host machine on the private network. Inbound messages are re-addressed and re-directed inside the network by the Passive RPAT device. The RPAT methodology requires two programs, a server program, and a client program. The Active RPAT device, acting as the client, issues the passive command to ask the Passive RPAT device which port to connect to in order to establish a data session. The Passive RPAT device, acting as the server, replies to the passive command with a unique port assignment and returns this port number to the Active RPAT device.

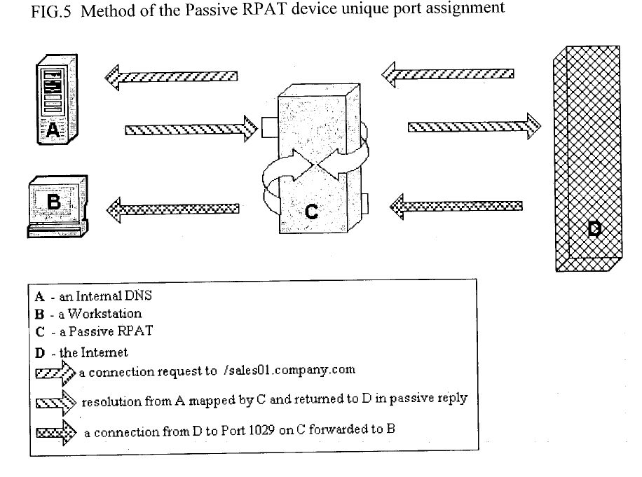

To use passive mode, an Active RPAT device, or an active host client allocates two TCP ports for its own use, the first port identifies a command channel and the second port identifies a data channel. The client opens the command channel port to contact the Passive RPAT device for address discovery and to issue the passive (PASV) command. The Passive RPAT device receives the PASV command on the command channel port as defined in FIG.5. The PASV command causes the Passive RPAT device to allocate a second port of its own for the data channel and tells the client (which may be either an active host or an Active RPAT device) the number of that port in the PASV reply. The port range selected must be in the non-privileged range (eg. greater than or equal to 1024); it is strongly recommended that the chosen range be large enough to handle many simultaneous passive connections (for example, 49152-65534, the IANA-registered ephemeral port range). The client then opens the data connection from its second port to the dynamic port assigned by the Passive RPAT device and indicated in the PASV reply (the data port the Passive RPAT device has opened for this connection and is listening on).

Well-known ports are standardized port numbers that enable remote computers to know which port to connect to for a particular network service. An example is the 80 port (HTTP Port), which is the standard port for web access. However, there are many services that do not have a standardized port number approved by the IANA. There is a second type of port number called a dynamically allocated port. As the name implies, dynamically allocated ports are not pre-assigned. They are assigned to processes when needed. The stated invention uses the passive command to generate these dynamically allocated ports and ensures that it does not assign the same port number to two processes, and that the numbers assigned are above the range of standard port numbers.

A DNS enquiry does not return a port to connect to as part of resolution, it returns an IP address. DNS relies on the system of standardized ports. However, a resource in the back of the network is not likely to have a standardized port, and with the ever increasing number of services that could be offered in the future this system is breaking down, evidence the increasing use of Java RMI and HTTP tunneling on networks. The method of reverse port address translation used by the Passive RPAT device provides a dynamic port for each connection session, tearing down that port when the session is terminated. In this way the port assignment is not by protocol or service but by session and is used specifically to identify the inbound connection. In this way the Passive RPAT device is a reverse proxy for a host with a private IP address and a protocol proxy for services that is not assigned a standard port.

As described, the stated invention uses the passive port assignment methodology to build inbound sessions to multiple hosts assigned private IP addresses. In FIG. 5, the client (active host) on the public network resolves a host name address (sales01.company.com) through the Passive RPAT device to the internal DNS. The internal DNS returns the private address 192.168.32.15 to the Passive RPAT device. The Passive RPAT device then maps the private address (192.168.32.15) to the dynamic port number (1029) that it has assigned for this session. The redirect for the inbound connection is mapped from 213.18.123.100.1029 to the private address 192.168.32.15. Each computer on the private network, assigned a private address, is translated to the same IP address (213.18.123.100). To establish a unique inbound connection using the same proxy address a different port number assignment is given to each TCP session connection. The client uses a standardized command structure to notify the Passive RPAT device of the passive command. The Passive RPAT device processes the command structure in the data packet received from the client on the command channel to determine the passive command set. A host residing outside the private network or subnet runs an application using this command structure to connect to the Passive RPAT device. The Passive RPAT device server issues a reply to the passive command sent by the client (notifies the client of the port number to connect to) and proceeds to bind the socket connection with the client to initiate a data session to the requested passive host. In this way the methodology of reverse port address translation used by the Passive RPAT device is to map the unique port number to the private address for each TCP session.

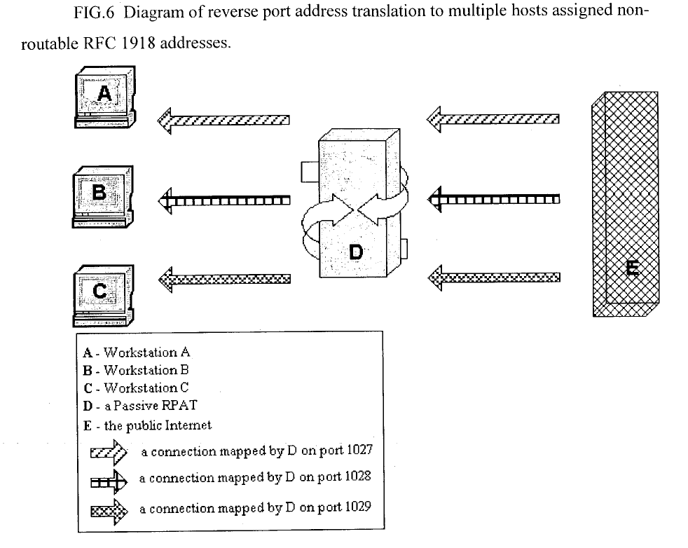

The internal IP range (192.16.32.xx) is an unregistered range that could be used by another network. Therefore, the Passive RPAT device is translating the addresses to avoid a potential conflict with another network. In FIG.6, the Passive RPAT device uses a uniquely assigned port to identify each TCP session; port 1027 is mapped to 192.168.32.10, port 1028 is mapped to 192.168.32.12, and port 1029 is mapped to 192.168.32.16. The Passive RPAT device acts as a redirct server once these connections have been established. It will also translate the unregistered local IP addresses back to the registered global IP address on the external port of the dual-homed Passive RPAT device when information is sent back to the public network.

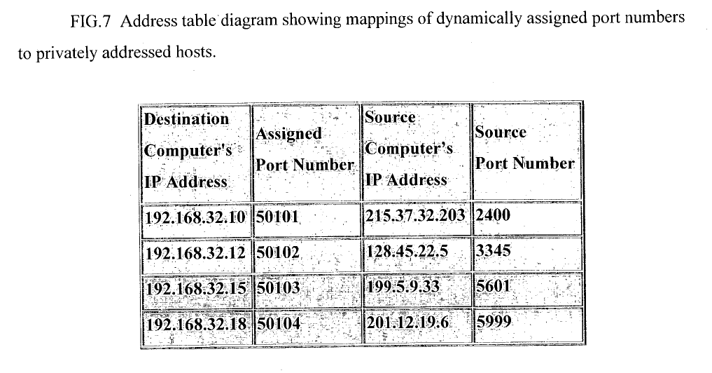

The Passive RPAT device maps the private address to the dynamic port assigned for the session and maintains a log of these address mappings, defined as an address table, so that it can intercept inbound packets and rewrite the packet header with the private address before forwarding, and vice versa. An example address table is diagramed in FIG. 7. Outbound packets that are part of this TCP session are also intercepted by the RPAT device and the packet header is rewritten so that the destination address is the unique IP address of the Passive RPAT device. It is important to note that the Passive RPAT device must translate the “internal” addresses to the registered unique address as well as translate the “external” registered addresses to addresses that are unique to the private network.

The basic proxy operation of a Passive RPAT device is as follows: An internal network has been set up with non-routable IP addresses (typically RFC 1918 addresses) that were not specifically allocated to that company by IANA. The organization deploys an RPAT device. The RPAT device has a unique IP address, given to the company by IANA, configured on the external serial port. The RPAT device is typically deployed as a reverse proxy for the internal DNS server and is dual-homed with a connection to the public network on one serial port and a connection to the private network on an Ethernet port. A computer on the Internet attempts to connect to a computer inside the private network by requesting resolution of an FQDN. The RPAT device receives the packet from the external DNS, or from an Active RPAT device, on the Internet. The Passive RPAT device forwards the DNS resolution header to the internal DNS for resolution. When a DNS resolution packet comes back from the internal DNS server, the Passive RPAT device assigns a unique port number to the Private IP address, saves the computer's non-routable IP address and the unique port number assigned for the session to an address table. The address table now has a mapping of the computer's non-routable IP address to the unique port number. The Passive RPAT device replaces the local computer's non-routable IP address with the external IP address configured on its serial port and then sends a passive reply to the client notifying it of the unique port where the RPAT device is listening for the connection. The client opens a connection to the IP address of the Passive RPAT device at the unique port assigned by the Passive RPAT device to initiate the TCP session. The Passive RPAT device checks the destination port on the packet. It then looks in the address table to see which private address on the local network the session has been assigned to. It rewrites the packet header and forwards the packet to the private address on the local network. The passive host computer receives the packet from the Passive RPAT device. When the passive host returns data on the TCP session channel the Passive RPAT device changes the source address and source port to the ones saved in the address table and sends it to the active host computer on the public network. The process repeats as long as the computer is communicating with the external system. Since the Passive RPAT device now has the computer's private address and source port saved to the address table, it will continue to use that same unique port number for the duration of the connection. A timer is reset each time the Passive RPAT device accesses an entry in the table. If the entry is not accessed again before the timer expires, the entry is removed from the table.

FIG.7 is a diagram of a table to show how the address table might appear with multiple inbound sessions. As you can see, the Passive RPAT device stores the IP address and port number of each computer in the address table. When it receives a packet from with an assigned port number it matches the port number identified in the socket address to the destination IP address listed in the table and then rewrites the packet with this destination address (the passive host Computer's IP Address) and forwards the packet. When the packet is returned in this session it rewrites the packet again, replacing the IP address of the passive host with the registered IP address of the RPAT device as the packets source address with the dynamic port number corresponding to the location, in the table. So any external network sees the Passive RPAT device IP address and the port number assigned by the proxy as the source-computer information on each packet.

The Passive RPAT device creates an address table listing when resolution is returned from the internal DNS. This initiates the Passive RPAT device to reply with two reply lines. The first line tells the client that the listing is ready, and that the client can make the second connection to the Passive RPAT device. The client connects to the IP address and port number given by the PASV reply, and sends or receives data until packet flow ceases and the log time is exceeded deleting the address table listing. The Passive RPAT device then closes the temporary data connection.

In order to generate an address table listing, the client and server use two socket connections, one for the command channel to establish control flow (client sends commands, the server replies in plain text) and one for the data channel to establish the data connection (which is continuous and asynchronous). When a second address table listing is generated, the Passive RPAT device and client will use another new (temporary) socket connection for the transfer.

The passive command is a standard networking technology that represents a connection redirect command. The passive command is used by the stated invention in a totally unique manner to establish a method of NAT for non-routable privately addressed hosts to be accessed from the Internet. A connection comes in on a command channel port and is redirected to a data channel port. In the stated invention, the passive command is used to assign a port to the connection session and to notify the active host of this port. The Passive RPAT device may reside on any port. The use of URI naming conventions and the DNS system have been used to diagram the invention because they are widely used today. Using DNS the Passive RPAT device is assumed to reside on the standardized DNS port. Once resolution to the address has been made and the private IP address has been proxied with the global IP address of the Passive RPAT device a port number must be assigned for the connection. This is required because the Passive RPAT device redirect operates at Layer 3 and 4 of the OSI model, it is not a Layer 7 proxy (operating at the application layer) and as a result has no knowledge after address resolution of the application the active host is trying to connect with. This disconnect has been resolved using the passive command, where by the Passive RPAT device notifies the client on which port it will be listening to establish the connection.

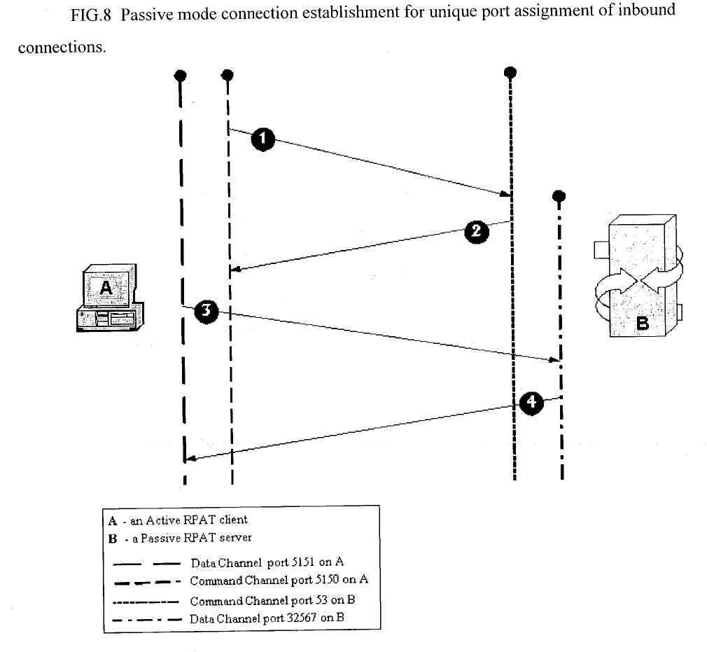

In FIG. 8 the passive mode connection establishment is defined in 4 steps. In step 1, the client contacts the Passive RPAT device on the command port and issues the PASV command. The Passive RPAT device then replies in step 2 with PORT 32567, telling the Active client which port it is listening to for the session connection. In step 3 the Active client then initiates the data connection from its data port (source port 5151) to the specified Passive RPAT device data port (destination port 32567). Finally, the Passive RPAT device server sends back an ACK in step 4 to the Active client's data port to conclude the 3-way TCP handshake.

A Passive RPAT device is primarily a TCP-based service, however, it can also be configured as a UDP service, and is unusual because it uses two or more simultaneous TCP connections. The first TCP connection is initiated from client to server. This connection, usually called the command channel, carries client commands and server command replies, discovery requests and resolution replies. The second TCP connection, usually called the data channel, is dedicated to TCP session establishment for connection to the resolved host name. The second TCP connection is set up and the unique port assignment for the session is communicated through use of the passive command.

Session establishment occurs when an Active client issues a PASV command and, if the Passive RPAT server responds positively, the Active client initiates the data TCP session at the port the Passive RPAT server has stated it will be listening on. The TCP port number is embedded in the command and reply. The method of NAT stated as Reverse Port Address Translation, and defined in this invention, permit a client-to-server (or server-to-server) data TCP connection to a privately addressed host when they detect the PASV command. The TCP port number is extracted from the PASV command so that only a specific data connection is allowed; no persistent holes in the firewall will occur.

As diagramed in FIG. 8 the Active client opens a control connection on port 53 (or to any port assigned to the name server) to the Passive RPAT server and then requests passive mode through the use of the “PASV” command. The Passive RPAT device queries the internal DNS for the host name private address. When the host name is successfully resolved to a private address and returned to the Passive RPAT device it then agrees to the PASV mode, and selects a random port number (>1023) and listens on this port. It supplies this port number to the client for data transfer and proxies its global address for the private address. The Active client receives this information and opens a data channel to the Passive RPAT device server at the dynamically assigned port. The Passive RPAT device server receives the data and sends an “OK” (ACK).

In passive mode the Active client initiates both a resolution and access connection to the Passive RPAT device. When opening a passive connection, in FIG. 8 the Active client opens two random unprivileged ports locally (N>1024 and N+1). The first port contacts the Passive RPAT server on port 53 (command channel), the client issues the PASV command in the command exchange along with the address discovery request. The result of this is that the Passive RPAT device server then opens a random unprivileged port (P >1024) and sends the PORT P command back to the Active client. The Active client then initiates the data connection from port N+1 to port P on the server to transfer data.

The port range selected must be in the non-privileged range (eg. greater than or equal to 1024); it is strongly recommended that the chosen range be large enough to handle many simultaneous passive connections (for example, 49152-65534, the IANA-registered ephemeral port range).

The Active client requests the Passive RPAT device to identify a non-default server side data port with the PASV command. This command binds new ports on both ends of the data connection. Since a connection is defined by the pair of socket addresses this establishes a unique data connection. This command requests the Passive RPAT device server to “listen” on a data port (which is a dynamic data port assigned for the TCP data session) and to wait for a connection rather than initiate one upon receipt of a transfer command. The response to this command includes the IP and port address this server is listening on. The PASV command tells the Passive RPAT device to prepare for a new socket connection by creating a new socket and listen for a connection from the Active client. The Passive RPAT device reply includes an IP address and a port number, encoded as 6 digits, separated by commas. The Active client must find and understand this address in order to receive the listing.

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as claimed. For example, the present invention is described using the current name server standard, the Domain Name System or DNS. It is important to understand as the use of look-up or name servers evolve on the Internet that the stated invention is designed to provide reverse proxy services in a similar manner as that described for DNS to any look-up or name server including WINS, Jini, UDDI, WSDL, etc., or any future service.

What I claim as my invention is:

1. A method for establishing an inbound connection from a device on the public network to a device on a private network, said private network using a system of private addressing, said methodology comprising:
a proxy server apparatus represented by a physical connection to both a public and private network segment with at least one host interface controller to receive and/or transmit data containing message headers, so as to move those messages across networks from a source device on the public network to a destination device on a private network, said device on the private network identified by a private address, and vice versa;
a request receiving means for receiving a plurality of address discovery requests from at least one of a plurality of client apparatuses residing on the public network, and a request receiving means for receiving a plurality of address resolution responses from at least one of a plurality of look-up or name servers residing on the private network;
a means for intercepting the address resolution from the look-up or name server, rewriting any network address that represent a private address listed in an address resolution response and replacing said address with the public address of the proxy server apparatus, assigning a unique port to identify the connection and transmitting the created socket address, including the public IP address of the proxy server apparatus and the dynamically assigned port, to the client;
a redirect methodology of creating means for sequentially mapping a plurality of resolution and access requests, each redirect specifying a reverse or regular mapping, including a methodology for the proxy server apparatus to trap for redirects from said name server or from said device on the private network, and a methodology for the proxy server apparatus to log reverse and regular mapping redirects of the socket address, created by the proxy server, to the hosts private address, provided by the look-up or name server.

2. A method according to claim 1, of accessing said device located on a private network from the public network by routing inbound packets by port address, said methodology assigning a unique port address to identify each inbound data session established by a plurality of clients on the public network connecting to a plurality of devices on a private network, said proxy apparatus using the passive command to notify the client of the unique port address assigned to the session, the method to comprise the steps of:
a client on the public network opens two random unprivileged ports locally (N>1024 and N+1), said first port to contact a proxy server apparatus and issue the passive command, said passive command instructs the proxy server apparatus to prepare for a new socket connection by creating a new socket and listen for a connection from the client at said socket number;
said proxy server apparatus in response to the passive command issued by said client then opens a random unprivileged port (P>1024) and sends a port command (port P) back to the client, said reply includes a new and unique socket number comprised of an IP address and a port number, encoded as 6 digits, separated by commas;
said client then initiates the inbound connection from port N+1 to port P on the proxy apparatus to establish a continuous synchronous or asynchronous data connection;
said port number is then used to uniquely identify each inbound packet in the session.

3. A method, according to claim 2, of redirecting an inbound connection request to a device, or devices, on a private network that requires a minimum of two ports be allocated on the client side requesting the connection and a minimum of two ports be allocated on the proxy server side receiving said connection, comprising the steps of:
allocating two ports for connection establishment of each session, said first port being a command channel between said client and said proxy server apparatus to query a host or resource name for location information of a privately addressed device and to exchange the passive command information to assign a unique port for the data connection and communicate that unique port assignment to the client as defined in claim 2;
the second port being a data channel between said client and said proxy server apparatus to establish a continuous synchronous or asynchronous session with said privately addressed device, said second port is a dynamic port assigned to uniquely identify the session established with said device on the private network as defined in claim 2.

4. A redirect methodology according to claim 1 and claim 2, comprising:
an address table, or set of address tables, to carry out packet redirection based upon a method for choosing a next-hop destination for each packet, each address table to store at least one pointer to at least one of said plurality of host devices for message distribution;
said methodology to include a process of recording the non-routable IP address and port number of the internal host residing on the private network to said address table;
said methodology to include a process of recording the unique session identification or port number that it has assigned for this session as defined in claim 2 to said address table;
said address table to perform mapping of non-routable IP address and port number of internal host to the unique port number assigned to the session as defined in claim 2 for translation of packets based upon this mapping for redirection and forwarding.

5. A process and methodology of network address translation according to claim 1 and claim 2 and claim 4, where a device on the public network attempts to connect to a device on an internal private network that has been assigned an IP address that is not unique and should be considered non-routable, comprising the steps of;
said proxy server apparatus, as defined in claim 1, receives a packet from said source device on the public network;
said methodology of unique port assignment, as defined in claim 2, using dynamically established ports to create a unique socket number for identifying network connections to internal devices on a private network assigned a private non-routable address;
said methodology of port mapping using address tables for connection redirection, as defined in claim 4, where a packet form a source device on the public network is received and the destination port on the packet is checked against listings in an address table;
said methodology comprising a process of reverse port address translation for inbound connection sessions to devices on a private network assigned non-routable private IP addresses by rewriting the destination address and destination port to the ones recorded in said address table, as defined in claim 4, and forwarding the packet to the mapped internal host;
said destination device residing on the internal private network receives the packet from said proxy server apparatus, as defined in claim 1;
said process repeats as long as said internal device is communicating with said external device.
